(19) United States
(12) Patent Application Publication
(10) Pub. No.: US 2025/0143506 A1
(43) Pub. Date: May 8, 2025

(54) Steam distributor for a coffee machine

(71) Applicant: NEXT LEVEL COFFEE GMBH, Konstanz (DE)

(72) Inventors: Marius Kütemeyer, Stuttgart (DE); Dominik Maier, Konstanz (DE); Markus Unger, Konstanz (DE)

(73) Assignee: NEXT LEVEL COFFEE GMBH, Konstanz (DE)

(21) Appl. No.: 18/838,909

(22) PCT Filed: Nov. 29, 2022
(86) PCT No.: PCT/EP2022/083691

§ 371 Date: Aug. 15, 2024

(30) Foreign Application Priority Data
Feb. 15, 2022 (DE) 10 2022 103 537.9

(51) Int. Cl. A47J 31/44

(52) U.S. Cl. CPC A47J 31/4489

(57) ABSTRACT

A steam distributor for a coffee machine and a coffee machine are described. The steam distributor includes a rod-like distributor body and an outlet area for discharging steam and/or air from an interior of the distributor body into a surrounding of the distributor body. The outlet area is arranged on an outer surface of the distributor body and is configured to discharge the steam and/or the air in such a way that the steam and/or the air forms a flow which has a tangential flow direction with respect to the distributor body and flows tangentially out of the distributor body. This structure of the distributor body allows milk or a milk substitute liquid to be foamed advantageously, because a circular flow is produced in the milk or the milk substitute liquid.

### TECHNICAL FIELD

The description relates to a steam distributor for a coffee machine, a coffee machine with such a steam distributor, and a system consisting of a coffee machine and a fluid container.

### TECHNICAL BACKGROUND

Coffee machines exist in various forms and categories. Coffee machines are usually used to produce coffee through a brewing operation. After the brewing operation, the coffee is available as a beverage in which the aroma and flavor have usually been extracted from coffee powder using hot water. The coffee can now either be drunk in this form or it can be enhanced with other ingredients, such as sugar or other sweeteners, aromatized additives, and milk or milk substitute liquids.

Milk or milk substitute liquids can be added to coffee in their original form. However, milk or a milk substitute liquid is often processed into a foam using a so-called frother and then added to the coffee, or the coffee is added to the processed foam.

Milk of animal origin is often used in this context. However, it is also conceivable to use milk substitute liquids of plant origin. Such milk substitute liquids can be produced from peas, lupins, oats, hemp, almonds, rice, soy, etc., for example. For reasons of readability, reference is often made to milk in the context of this description. However, it should be understood that the reference to milk always means a foaming liquid of animal or vegetable origin that can be used as a coffee additive.

Various techniques are known for the production of milk foam. For example, an element with an irregular surface structure in the milk can be set in motion or rotation, wherein the milk is foamed due to its composition (in particular its fat and protein content). Alternatively, the milk can be foamed with a pressurized fluid or gas, such as steam or a steam-air mixture, by introducing this fluid or gas at the appropriate pressure into the milk in a container. In this second approach, a so-called steam distributor is used to introduce the fluid or gas into the milk. Producing high-quality milk foam with a steam distributor sometimes requires skill and experience on the part of the person producing it. The production of milk foam with a steam distributor usually takes place in two phases: in a first phase, the steam distributor or the container with milk is held in such a way that the steam distributor is close to the surface of the milk and thus some air is sucked in from the surface and introduced into the milk; at a certain milk temperature, the steam distributor is immersed deeper into the milk, so that in this second phase the milk is essentially swirled without the addition of further air.

### DESCRIPTION

It can be considered an object to improve the production of high-quality milk foam using a steam distributor.

This object is solved by the object of the independent claim. Further embodiments are shown in the dependent claims and in the following description.

According to one aspect, a steam distributor for a coffee machine has a rod-like distributor body and an outlet area for discharging steam and/or air from an interior of the distributor body into a surrounding of the distributor body. The outlet area is arranged on an (lateral) outer surface of the distributor body and is configured to discharge the steam and/or air such that the steam and/or air forms a flow which has a tangential flow direction with respect to the distributor body and flows tangentially out of the distributor body.

The steam distributor is usually connected to the coffee machine or a source of pressurized fluid (steam and/or air). For this purpose, the coffee machine or said source has a water container with a heating element and a pump. The pump conveys the fluid to the steam distributor, where the fluid exits at a corresponding speed.

The steam distributor is, for example, tubular or rod-shaped. The steam distributor usually has an elongated or linear end section with which the steam distributor is immersed in the milk to be foamed. The steam distributor can be movably, pivotably or rotatably arranged on a housing of the coffee machine so that a container with milk can be placed under the steam distributor and the steam distributor can be immersed in the milk.

In the steam distributor described here, the outlet area for steam and/or air is arranged on an outer surface of the distributor body. The outlet area is also designed so that the steam and/or air leaves the outlet area in such a way that the generated flow has a tangential flow direction. The steam and/or air is therefore neither expelled from an end face of the steam distributor in the longitudinal direction of the steam distributor nor is the steam and/or air expelled from the outside surface in a radial direction. Rather, the outlet area guides the steam and/or air in a direction with a tangential movement component with respect to the distributor body of the steam distributor.

The fact that steam and/or air flows tangentially out of the distributor body means that the direction of flow of the steam and/or air runs perpendicular to a longitudinal axis or direction of extension of the distributor body. The flow can flow at least in sections along the outer surface in order to indicate or induce a circular or spiral flow.

The flow exiting the outlet area has a tangential flow direction and flows tangentially out of the distributor body and at least in sections around the distributor body. This means that the outgoing flow has at least one directional component that extends tangentially around the distributor body.

With this design of steam distributor, the fluid leaving the outlet area will typically not move completely linearly after it has left the outlet area. Rather, the curved or convex outer surface in the circumferential direction of the distributor body has the effect that the fluid at least partially and in sections follows the curvature of the outer surface in the circumferential direction. This advantageously supports the creation of a swirl or rotation in the container with milk, which makes it possible to produce high-quality milk foam.

Such a swirl or rotation cannot be generated to the same extent if the fluid leaves the outlet area in a straight line (in the longitudinal direction or in the radial direction of the distributor body). In order to generate a swirl with a fluid flowing in a straight line in the container with milk, it is necessary to manually adjust the position of the container in relation to the steam distributor and to adjust it if necessary. In the steam distributor described here, the outlet area is arranged in such a way that the outflowing fluid automatically creates a swirl in the container with milk due to the predetermined tangential flow direction and the fact that the outflowing fluid follows the contour of the curved/convex outer surface in the circumferential direction.

According to an embodiment, the outlet area contains an opening, the opening being arranged in such a way that steam and/or air flowing from it flows at least in sections in the circumferential direction along the outer surface.

According to a further embodiment, the opening is a slit or a nozzle.

The outlet area may contain several such openings. For example, the outlet area contains multiple slits, each of which extends in the longitudinal direction of the distributor body. The multiple slits can be arranged next to each other in the circumferential direction. However, it is also conceivable that two or more slits are arranged next to each other in the longitudinal direction and are separated from each other by a thin web. The outlet area can also contain several nozzles, which are distributed regularly or irregularly in the outlet area over the outer surface of the distributor body. It is also conceivable that slits and nozzles are used in the outlet area. For example, the nozzles can be designed to release steam and the slits can be designed to introduce air.

According to a further embodiment, the distributor body has a circular cross-section and the outlet area extends on the outer surface of the distributor body in the longitudinal direction of the distributor body.

Usually, the outlet area on the outer surface of the distributor body forms an area that extends further in the longitudinal direction of the distributor body than in the circumferential direction of the distributor body. The reason for this design is that it allows a circular flow to be generated around the distributor body at different depths in the milk. A steam distributor with this structure causes a circular flow in a fluid container when the steam distributor is immersed in the liquid and steam and/or air is transported out of the outlet area.

According to a further embodiment, the steam distributor further comprises a closure slide which can be moved in the longitudinal direction of the distributor body and is arranged in such a way that the closure slide covers or exposes a variable area of the outlet area.

The closure slide is arranged in or on the distributor body. For example, the closure slide is held in the distributor body in a sliding manner, such as in a plain bearing or the like. The closure slide can be moved in the longitudinal direction of the distributor body, covering part of the outlet area. This reduces the effective cross-section or the number of free openings in the outlet area. This happens in particular when the closure slide is moved in the direction of an end face of the distributor body. By moving the closure slide in the direction of the end face, it covers part of the outlet area and the openings contained therein, so that the area of the outlet area from which steam and/or air escapes is reduced. In this way, the outlet area can be adapted to a fill level in a container so that steam and/or air preferably only escapes in the area of the outlet area that is in the liquid.

According to a further embodiment, the steam distributor further comprises an actuation device, wherein the actuation device is mechanically coupled to the closure slide so that the closure slide can be moved by means of the actuation device.

The actuation device is used to bring the closure slide into a desired position so that no steam and/or air escapes from the outlet area above the liquid. This ensures that all of the steam and/or air is introduced into the milk.

According to a further embodiment, the actuation device is a lever or a float.

The actuation device can be used to push the closure slide into a desired position. This can be done using a lever, for example, which is operated manually. Alternatively, a float is arranged on the steam distributor, which is mechanically coupled to the closure slide. The float is designed to float on a surface of a liquid so that the float is moved relative to the distributor body when the distributor body is immersed deeper or less deeply into a liquid. During this movement of the float relative to the distributor body, the closure slide in the distributor body is also moved and covers a larger or smaller area of the outlet area. This allows the closure slide to be positioned in the outlet area at the fill level or at the relative position of the outlet area to the liquid.

The closure slide can be coupled to the float in such a way that the outlet area on the distributor body is only released from a certain distance below the surface of the liquid. In other words, the closure slide has an offset along the longitudinal direction of the distributor body with respect to the float, so that a lower edge of the closure slide is closer to the front side of the distributor body than a lower edge of the float.

According to a further embodiment, the steam distributor has a first conduit and a second conduit, which are located in an interior of the steam distributor and extend to the outlet area. The first conduit is designed to conduct steam to the outlet area. The second conduit is designed to conduct air to the outlet area.

By means of the first conduit and the second conduit, a steam-air mixture can be generated, which escapes from the outlet area into the surrounding milk.

It is also conceivable that a steam-air mixture is generated upstream of the outlet area and fed to the outlet area by means of a single conduit.

According to a further aspect, a coffee machine is provided which is configured to brew a coffee. The coffee machine comprises a steam distributor as described herein.

According to a further aspect, a system is disclosed, comprising a coffee machine as described herein and a container. The steam distributor is designed to be immersed in a liquid located in the container and to foam the liquid by means of steam and/or air escaping from the outlet area of the steam distributor.

The steam distributor described here, on its own and in conjunction with a coffee machine or system, improves the foaming and heating of milk in that the outlet area causes steam and/or air to flow in a circumferential direction around the distributor body. The resulting swirl ensures an even distribution of the air introduced into the milk and improves the quality of the foamed milk. With the geometry of the steam distributor described here, the production of milk foam is virtually independent of the positioning of the steam distributor in the milk. The outlet area is preferably designed in such a way that all openings arranged therein eject the fluid in the same tangential flow direction.

### BRIEF DESCRIPTION OF THE DRAWINGS

In the following, the enclosed drawings are used to describe embodiments in more detail. The illustrations are schematic and not to scale. Identical reference signs refer to identical or similar elements. It is shown in

FIG. 1 a schematic representation of a system with a coffee machine and a milk container.

FIG. 2 a schematic representation of a steam distributor in a milk container.

FIG. 3a schematic representation of the cross-section of a steam distributor.

FIG. 4a schematic representation of the cross-section of a steam distributor.

FIG. 5 a schematic representation of a steam distributor in a milk container.

FIG. 6 a schematic representation of a steam distributor.

FIG. 7 a schematic representation of a steam distributor.

FIG. 8 a schematic representation of a steam distributor.

FIG. 9 a schematic representation of a steam distributor.

FIG. 10 a schematic representation of a steam distributor.

FIG. 11 a schematic representation of the cross-section of a steam distributor.

### DETAILED DESCRIPTION OF EXEMPLARY EMBODIMENTS

FIG. 1 shows a system 1 with a coffee machine 10 and a container 200. The container 200 can be referred to as a milk container, for example, and contains a liquid 210, which is usually milk. The liquid 210 is filled in the container 200 up to a fill level 220, wherein the fill level 220 also corresponds to the surface of the liquid 210. Not all technical elements of the coffee machine 10 for the brewing operation of a coffee are shown here. Rather, only some of those elements are shown which are directly or indirectly functionally related to the steam distributor 100.

The coffee machine 10 comprises a water container 12, a boiler 14 and a pump 16. Water is stored in the water container 12 for the brewing operation of a coffee and for the generation of steam. Water is heated in the boiler 14. The pump 16 transports the water or steam to the steam distributor 100.

The steam distributor 100 is fixedly or movably attached to the coffee machine 10. In principle, the steam distributor 100 can be shaped in any way. The steam distributor 100 has a distributor body 101. The steam distributor 100 as a whole or the distributor body are preferably made of metal, for example stainless steel. Other materials can be used, for example plastic or ceramic, wherein the type of material has no direct influence on the design of the steam distributor 100 and the outlet area described below.

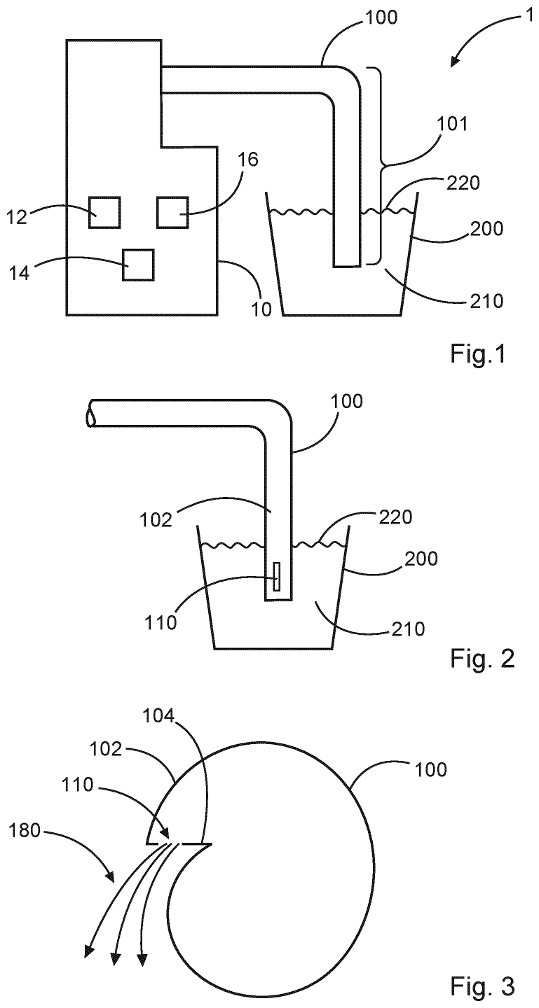

FIG. 2 shows a steam distributor 100 with the outer surface 102 and the outlet area 110 arranged on the outer surface 102. The steam distributor is immersed in the liquid 210 of the container 200. The outlet area 110 is completely immersed in the liquid 210 and is located below the surface of the liquid 110.

FIG. 3 shows a schematic representation of the cross-section of the steam distributor 100 in the area in which the outlet area 110 is located on the outside surface 102 of the distributor body. It can be seen from this illustration that the cross-section of the steam distributor is essentially circular and has an outside surface that is curved or convex in the circumferential direction. The steam distributor 100 may have a radial constriction 104. The outlet area 110 is arranged in this radial constriction, so that steam and/or air escaping from the outlet area 110 causes a flow 180 which has a flow component in the circumferential direction or tangential direction of the steam distributor.

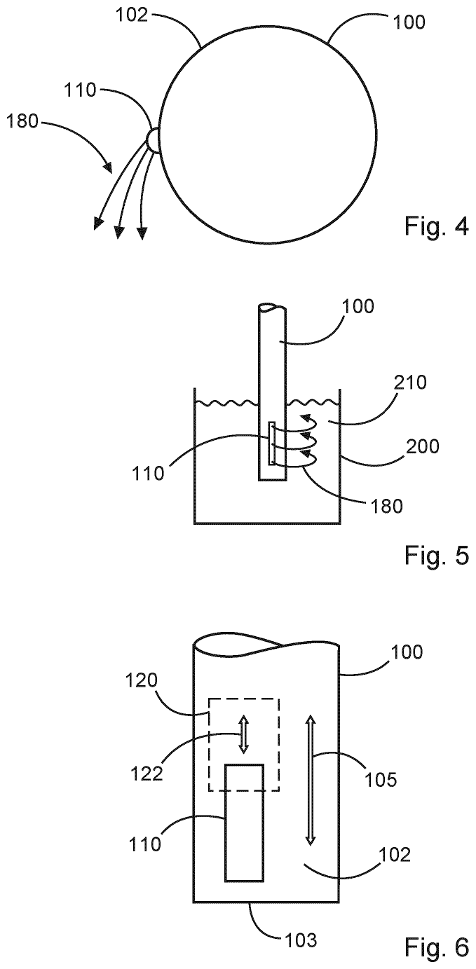

FIG. 4 shows a schematic representation of the cross-section of the steam distributor 100 similar to FIG. 3, but with a differently designed outlet area 110. While the outlet area 110 in FIG. 3 is a slit which extends into the plane of the drawing, the outlet area 110 in FIG. 4 is a nozzle which is located on the outer surface 102 of the steam distributor 100. The nozzle can be aligned in such a way that it also generates a flow 180 in the circumferential direction of the steam distributor 100.

In both FIG. 3 and FIG. 4, steam and/or air escaping from the outlet area 110 follows the convex outer surface 102 of the steam distributor 100 and produces a swirl in the container that is advantageous for the formation of milk foam.

FIG. 5 shows a steam distributor 100 in the liquid 210 of the container 200. The outlet area 110 is located completely in the liquid 210, i.e., below the surface of the liquid 210. Steam and/or air escapes from the outlet area 110 and is guided around the steam distributor 100 in the circumferential direction, as shown by the arrows for the flow 180.

FIG. 6 shows a steam distributor 100 with an outlet area 110 for steam and/or air and a closure slide 120. The closure slide 120 can be moved along the direction of movement 122 and thereby cover or uncover a part of the outlet area 110, depending on the direction in which the closure slide 120 is moved. The direction of movement 122 of the closure slide 120 preferably corresponds to the longitudinal direction 105 of the steam distributor 100.

In an initial state, the closure slide 120 is positioned in such a way that there is no overlap between the closure slide 120 and the outlet area 110. In this initial state, the closure slide 120 is further away from the front side 103 of the steam distributor 100 than shown in FIG. 6. FIG. 6 shows an intermediate state in which the closure slide 120 partially overlaps the outlet area 110. In a state of maximum coverage, the closure slide 120 can cover the entire outlet area or a large part of the outlet area 110. The closure slide 120 can be designed and arranged in such a way that it covers a desired section of the outlet area 110 in the state of maximum coverage.

In the initial state, the closure slide 120 is at maximum distance from the front side 103 of the steam distributor 100. In the maximum overlap state, the closure slide 120 is closer to the front side 103.

It can also be seen from FIG. 6 that steam and/or air emerges from the (lateral) outside surface 102 of the steam distributor 100 described here and not from the front side 103.

In FIG. 6, the closure slide 120 is drawn with dashed lines because the closure slide 120 is located inside the steam distributor 100 in this example. For example, the closure slide 120 may be located in the outside surface 102 of the steam distributor 100 or on the inside of the outside surface 102. The closure slide 120 may be slidably mounted in or on the outside surface 102 to allow movement 122 in the longitudinal direction 105 of the steam distributor. The closure slide 120 may be sealed with respect to the outside surface 102 by a seal (not shown).

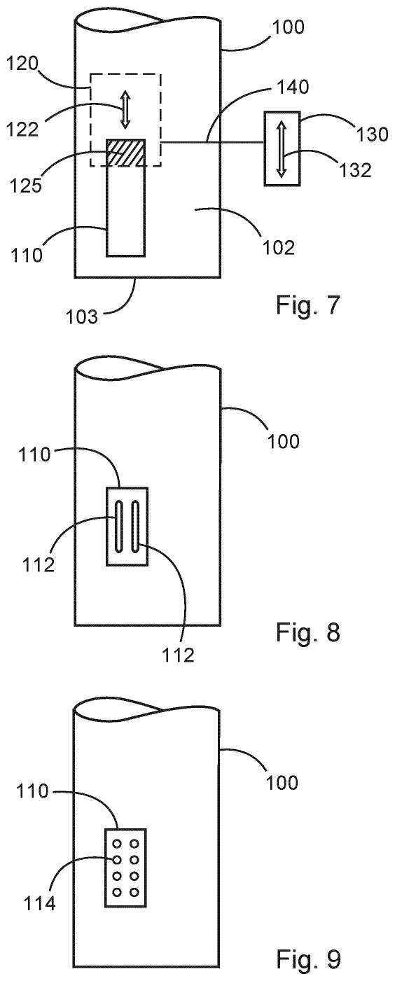

FIG. 7 shows an example of how the closure slide 120 can be moved along the direction 122 with respect to the steam distributor 100 in order to cover or uncover a covered area 125 of the outlet area 110. The further the closure slide 120 is moved relative to the outer surface 102 in the direction of the front side 103, the larger the covered area 125 and the smaller the effective cross-section of the opening of the outlet area 110 from which steam and/or air can escape.

The closure slide 120 is connected to an actuation device 130 via a rod assembly 140. The actuation device 130 is located outside the outer surface 102 of the steam distributor 100. The actuation device 130 can be moved along the outer surface 102 as indicated by the direction of movement 132. The actuation device 130 is mechanically coupled to the closure slide 120. As soon as the actuation device 130 is moved, the closure slide 120 moves relative to the outlet area 130.

The actuation device 130 can be designed as a manually operated lever or as a float. By means of the actuation device 130, the size of the outlet area 110 can be adapted to the fill level of the liquid in the container. If the actuation device 130 is designed as a float, it floats on the surface of the liquid in the container and moves the closure slide 120 into a corresponding position in relation to the outlet area 110 depending on the fill level.

FIG. 8 shows an exemplary embodiment of the outlet area 110 of the steam distributor 100. In this variant, the outlet area 110 contains two slits 112 that extend in the longitudinal direction of the steam distributor 100. FIG. 9 shows an alternative embodiment of the outlet area 110, in which the outlet area 110 has several nozzles 114. The slits 112 and the nozzles 114 are arranged and designed in such a way that they generate a flow 180 (see FIG. 3 and FIG. 4).

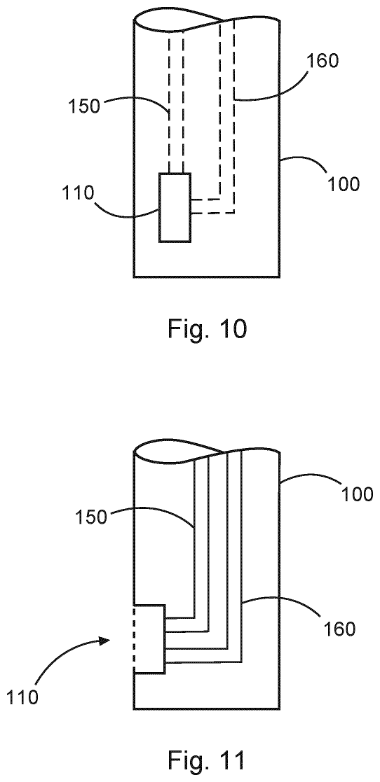

FIG. 10 schematically shows the supply of steam and/or air to the outlet area 110 of the steam distributor 100. A first conduit 150 and a second conduit 160 are arranged inside the steam distributor 100. The first conduit 150 is, for example, an air conduit and the second conduit 160 is, for example, a steam conduit. Steam and/or air are selectively fed to the outlet area 110 via these two conduits 150, 160.

The type and quantity as well as the pressure of the fluid (steam and/or air) supplied to the outlet area 110 can be set or predefined via input elements (not shown) on the coffee machine 10 (see FIG. 1).

FIG. 11 shows a cross-sectional view of the steam distributor 100 of FIG. 10. In FIG. 11, it can be seen that the first conduit 150 and the second conduit 160 are led to the outlet area 110, where steam and/or air are released into the surrounding.

Even if the first conduit 150 and the second conduit 160 are shown as separate conduits in the interior of the steam distributor 100 in FIGS. 10 and 11, it should be understood that steam and/or air can be conducted in separate areas of the interior volume of the steam distributor 100 and that separate conduits need not be provided for this purpose. It is also conceivable that a steam-air mixture is fed to the outlet area 110 via a single conduit if this mixture is generated before it is fed to the single conduit.

In addition, it should be noted that “including” or “comprising” does not exclude other elements or steps and “a” or “an” does not exclude a plurality. Furthermore, it should be noted that features or steps described with reference to one of the above embodiments may also be used in combination with other features or steps of other embodiments described above. Reference signs in the claims are not to be regarded as a limitation.

### LIST OF REFERENCE SYMBOLS

1 system
10 coffee machine
12 water container
14 boiler
16 pump
100 steam distributor
101 distributor body
102 outside surface
103 front side
104 radial constriction
105 longitudinal direction
110 outlet area
112 slit
114 nozzle
120 closure slide
122 direction of movement
125 covered area
130 actuation device (lever, float)
132 direction of movement
140 rod assembly
150 first conduit, steam conduit
160 second conduit, air conduit
180 flow
200 container
210 liquid
220 fill level

1. A steam distributor for a coffee machine, comprising:
a rod-like distributor body;
an outlet area for discharging at least one of steam or air from an interior of the distributor body into a surrounding of the distributor body;
wherein the outlet area is arranged on an outer surface of the distributor body and is configured to discharge at least one of the steam or the air in such a way that the steam or the air forms a flow having a tangential flow direction with respect to the distributor body and flows tangentially out of the distributor body.

2. The steam distributor according to claim 1,
wherein the outlet area contains an opening; and
wherein the opening is arranged in such a way that at least one of the steam or the air flowing from the opening flows at least in sections in a circumferential direction along the outside surface.

3. The steam distributor according to claim 2,
wherein the opening is a slit or a nozzle.

4. The steam distributor according to claim 1,
wherein the distributor body has a circular cross-section, and the outlet area extends on the outer surface of the distributor body in a longitudinal direction of the distributor body.

5. The steam distributor according to claim 1,
wherein the steam distributor further comprises a closure slide movable in a longitudinal direction of the distributor body and arranged such that the closure slide covers or exposes a variable area of the outlet area.

6. The steam distributor according to claim 5,
wherein the steam distributor further comprises an actuation device; and
wherein the actuation device is mechanically coupled to the closure slide so that the closure slide can be displaced by the actuation device.

7. The steam distributor according to claim 6,
wherein the actuation device is a lever or a float.

8. The steam distributor according to claim 1, further comprising:
a first conduit and a second conduit, located in an interior of the steam distributor and extending to the outlet area;
wherein the first conduit is configured to conduct steam to the outlet area; and
wherein the second conduit is configured to conduct air to the outlet area.

9. A coffee machine, configured to brew coffee;
wherein the coffee machine comprises a steam distributor according to claim 1.

10. A system, comprising:
a coffee machine according to claim 9, and a container;
wherein the steam distributor is configured to be immersed in a liquid located in the container and to foam the liquid by at least one of the steam or the air escaping from the outlet area of the steam distributor.
